(19) United States
(12) Patent Application Publication
(10) Pub. No.: US 2016/0253935 A1
(43) Pub. Date: Sep. 1, 2016

(54) DISPLAY SYSTEM AND METHOD FOR PRODUCING SAME

(71) Applicant: BARCO N.V., Kortrijk (BE)

(72) Inventors: Peter GERETS, Roeselare (BE); Dirk MAES, Bissegem (BE); Claude TYDTGAT, Ledegem (BE); Johannes BRANDS, Taipei (TW)

(73) Assignee: BARCO N.V., Kortrijk (BE)

(21) Appl. No.: 15/032,280

(22) PCT Filed: Oct. 31, 2014
(86) PCT No.: PCT/EP2014/073475

§ 371 Date: Apr. 26, 2016

(30) Foreign Application Priority Data
Oct. 31, 2013 (GB) 1319239.8

(51) Int. Cl. G09G 3/00

(52) U.S. Cl. CPC G09G 3/006; G09G 2300/026; G09G 2320/029; G09G 2320/043; G09G 2360/145; G09G 2300/0426; G09G 2320/0693

(57) ABSTRACT

A display system, including a display device having an image forming device and an electronic driving system for driving the image forming device; a light source to illuminate a representative part of the display device; and an optical sensor unit having an optical aperture and at least one photo-sensor arranged to make optical measurements from the light reflected by the representative part and to generate optical measurement signals. The light source and the optical sensor unit are on one side of the display device. The light source and the optical sensor unit are integrated with the display device. Additionally, a method of producing a display system, a method for calibrating the display device, and a display device having a flexible second substrate.

### FIELD OF THE INVENTION

The present invention pertains to a display system, a method for producing same, and a method for calibrating a display device in same. In particular, the present invention allows for correction of gray level and/or color of an image displayed on a display device.

### DISCUSSION OF THE PRIOR ART

Large tiled displays have been realized with liquid crystals (LC), light emitting diodes (LED), organic light emitting diodes (OLED) and more recently with electrophoretic (EP) panels. Those panels are array displays of N×M picture elements or pixels. If the display can be driven in a matrix structure (active or passive matrix) the number of drivers and interconnections can be reduced. But even then, setting the pixels requires the drive of M+N conductive lines to control the state of the pixels (e.g. M select signal lines and N video signal lines). Those lines occupy spaces on a substrate together with the driver circuits (which may be referred to as chips or IC in the remainder of the text) and the LC, OLED or EP elements. The space occupied by the M+N conductive tracks and the driver chips will usually be non-display area, i.e. a part of a tile realized with a LC, OLED or EP panel will not display any picture elements that they could control.

The problem of non-display area has multiple causes. One of them, as reported in U.S. Pat. No. 6,147,724 concerning an LC display, is that of drive circuits and interconnections.

The liquid crystal display (LCD) device comprises an LCD panel for displaying an image and a drive circuit. The drive circuit is provided around the LCD panel and constitutes a non-display area (so-called picture-frame area) that does not contribute to the display. In a tiled display, the non-display area surrounding the LC or EP panel will contribute to the seam existing between display areas on adjacent tiles. In order not to degrade image quality, the seams have to be rendered as small as possible, in particular as narrow as possible. Certain picture-frame reduction techniques have been employed to reduce the non-display area. Such picture-frame reduction techniques are disclosed in Japanese patent application nos. 75019/1994 (JP H07-281183) and 297234/1995 (JP H09-138404) and have been successful to some extent. These solutions are nevertheless not satisfactory when a tiled display without discernible seams is required.

Flexible substrates have been used to increase the ratio of the display area in the whole liquid crystal panel as in e.g. Japanese unexamined patent publication (KOKAI) no. JP H05-107551, where a display has a structure in which a plurality of IC chips and connection terminals of the IC chips are arranged on a straight line and a flexible substrate is disposed in an overlapping relationship with the terminals and the IC chips.

This structure allows the area of a peripheral portion of a glass substrate to be reduced because the flexible substrate is simply disposed in an overlapping relationship with the terminals and the IC chips.

However, this structure has a problem in that operations to connect the flexible substrate and the terminals become complicated after the flexible substrate is overlapped with the IC chips and the terminals, thereby increasing the difficulty of the assembly process.

The inventors of this invention, however, have found that problems still remain to be solved in making the display area larger and the picture-frame area smaller than those of the conventional devices.

EP 1 039 788 A2, entitled “Flexible printed wiring board, electro-optical device, and electronic equipment”, discloses an electro-optical device capable of simplifying a terminal connecting process and increasing the ratio of a display area. Connection terminals connected to a scanning driver IC chip are arranged on a short side of a wiring connection area of a second substrate in an LCD panel, and the connection terminals arranged on a long side of a wiring connection area of a first substrate are connected from the same direction with a single flexible printed wiring board. For this reason, the convenience of the flexible printed wiring board can be improved. In addition, it is possible to reduce the projection size of the wiring connection area of the first substrate, and the ratio of the display area in the whole LC panel can be increased. Nevertheless, the driver ICs and some interconnections still occupy a picture-frame area that will contribute to the seam existing in a tiled display obtained by tiling electro-optical device as described in EP 1 039 788 A2.

To make matters worse, a tiled display should be equipped with a feedback system to monitor the variation over time of the luminosity, gray scales etc. of the display panel.

Different techniques have been proposed to evaluate these variations indirectly by monitoring e.g. the temperature, the drive current of test pixels (amplitude and/or time response of pixels . . . ). Those methods usually rely on a model of the panel. The models being only an approximation of the reality, the performance of the compensation methods making use of those models is not always sufficient for high-end applications or when a new display technology is introduced with little or no experience over its life time in the field.

Methods have thus been developed to monitor the variations over time of parameters like luminosity, gray scale, etc., of panels by direct monitoring of those parameters.

In U.S. Pat. No. 7,166,829 B2, assigned to the present applicant, entitled “Method and system for real time correction of an image”, a sensor is placed in front of the LC panel. While the area occupied by the sensor represents less than 1% of the display area; this is sufficient to disqualify this solution for the type of displays considered with the present invention.

EP 2332138 A1, in the name of the present applicant, relates to a method for compensating ageing effects of pixel outputs displaying an image on a display device. The method comprises displaying a first image on an active display area on the display device having a first plurality of pixels; displaying a second image on a sub-area of the display device and having a second plurality of pixels, the active display area being larger than the sub-area and the second image being smaller than the first image and having fewer pixels than the active display area; driving the pixels of the sub-area with pixel values that are representative or indicative for the pixels in the active display area; making optical measurements on light emitted from the sub-area and generating optical measurement signals therefrom, and controlling the display of the image on the active display area in accordance with the optical measurement signals of the sub-area. The advantage of the proposed method is that the sub-area being monitored has the exact same characteristics as the active display area, both areas being part of the same panel as they underwent the exact same manufacturing process. But the test area contributes to the picture frame and imposes a lower limit to the picture frame area and layout.

In U.S. Pat. No. 7,839,091, entitled “Light source control device, illumination device, and liquid crystal display device”, a light source control device includes a photo-sensor that detects emission brightness of a plurality of light sources emitting different colors of light, and controls emission brightness of at least one of the plurality of light sources on the basis of a detection result of the light detection device. The light source control device is configured so that: a through hole is provided to a reflective member that reflects light emitted from the light source in direction of a liquid crystal panel; the light detection device is provided on the opposite side to the light source side across the reflective member; and a light guide through which light from the light source can be propagated to the photo-sensor is provided to the through hole. The light propagation member and the trough hole make this solution minimally invasive and invisible to viewers but no information is obtained concerning the light values themselves: the achievable grayscales, response time etc. cannot be evaluated.

US 2005/0219272 describes an electrophoretic display device with automatic grey scale control. The display device has a photo-sensor positioned in a reservoir of the device adjacent to a pixel part. The photo-sensor monitors the amount of scattered light. The pixels of the electrophoretic display of the reservoir type in accordance with the prior art, comprise a pixel part and a reservoir part. A display is built up by a plurality of such pixel elements, being driven by active array driving. The driven pixel element comprises a layer of electrophoretic material, such as a transparent, translucent or light colored solution carrying dark colored, absorbing particles, being arranged between a front layer and a back layer, being an active plate. In the pixel part, on said back layer, a reflecting element is arranged to reflect ambient light falling onto the display and entering through the electrophoretic layer, and in the reservoir part, on said front layer a blocking element is arranged to block ambient light from entering directly into the reservoir part of the display device. Depending on the state of driving, the colored particles of the electrophoretic layer may move in and out of the visible pixel part and thereby generate a desired visible grey level of the pixel part. As indicated above, in this display, ambient light is allowed to pass through the electrophoretic layer and onto the back layer, being an active plate. According to the invention the intensity of the incident light falling onto the pixel part may be measured, this being a measure of the grey scale level of the pixel. This may be done by using a photo-sensor. The photo-sensor may be positioned in the reservoir part of the display element, adjacent to the pixel part. In this case, light is detected by the photo-sensor after being reflected by the reflecting element in the pixel part. A portion of the incident light is absorbed by the colored particles being present in the pixel part, and hence the photo-sensor signal detected will be dependent upon the amount of colored particles present in the pixel part.

Depending on the technology used to manufacture the electrophoretic sheet; it may or may not be possible to integrate a photo-sensor in a pixel. The level of ambient light being variable, it may also be difficult to link the amplitude of the photo-sensor signal to a change in the characteristics of a pixel or to a change in the level of ambient light impinging on the display. The solution proposed in US 2005/0219272 is thus not always applicable.

WO 2003/100514 A1 discloses the use of an optical sensor to detect the optical state of each pixel, and this is used to control the pixel drive signals. This approach requires compensation for the ambient light level. This can be achieved with further ambient light sensors, or else the pixel light sensors can be used as ambient light sensors before the display is operated. This means that significant additional circuitry is required or a complicated drive scheme has to be implemented.

WO 2008/018016 A1 describes an active array electrophoretic display device which comprises an array of rows and columns of display pixels. Each pixel comprises a plurality of sensors for detecting movement of the electrophoretic display particles, different sensors detecting particle movement which reaches different regions within the pixel. The invention uses multiple in-pixel sensors, and determines the pixel optical state by using a relationship between the sensor outputs which is independent of ambient light. In this way ambient light compensation is carried out simultaneously with the addressing of the pixel, and without requiring dedicated ambient light sensors. The main drawback of this approach is the significant added complexity of the display backplane. Multiple sensors in each pixel are required, as well as multiple sensing lines per column and multiple selection transistors to select a certain row of sensors. Furthermore, the practical use is questionable. Ideally, one would drive the display to become darker or brighter until the sensors feed back the desired gray level. But if one stops the driving, the particles having a certain speed will still move a bit, so one will always overshoot the target. A controlled deceleration would be required. However the response of the electrophoretic display is quite slow, it would not be acceptable to address row by row and wait for each row to stabilize; as each row would take more than 100 ms, updating an entire display would take multiple seconds.

Hence, there is a need for improvement of the art.

### SUMMARY OF THE INVENTION

It is an object of embodiments of the present invention to overcome at least some of the disadvantages mentioned above.

According to an aspect of the present invention, there is provided a display system, comprising: a display device having an image forming device and an electronic driving system for driving the image forming device; a light source to illuminate a representative part of the display device; and an optical sensor unit comprising an optical aperture and at least one photo-sensor, arranged to make optical measurements from the light reflected by said representative part and configured to generate optical measurement signals therefrom; wherein the light source and the optical sensor unit are on one side of the display device; and wherein the light source and the optical sensor unit are integrated with the display device.

The display device, in particular the image forming device, may have an active display area for displaying the image. Accordingly, the image may be displayed on a part of the image forming device, said part thus forming the active display area. The representative part of the display device may be a part of the image forming device that does not belong to the active display area. In one preferred embodiment, the active display area and representative part are devices that are fabricated together (i.e. the representative part and the active display area are from “the same batch”). In another preferred embodiment, the representative part is a continuation of the active display area on one integrated image forming device. In other words, the part representative of the display device and the active display area may be part of the same image forming device and in particular of the same electrophoretic layer. In the case of a sheet-like image forming device, like e.g. e-paper, the part representative of the image forming device and the display area are preferably part of the same sheet.

The light source and the optical sensor unit may be permanently integrated with the display device.

The present invention thus allows for the correction, through optical feedback, of gray level and/or color of an image displayed on a reflective display device.

In an embodiment of the display system according to the present invention, the light source and the optical sensor unit are configured to update the optical measurement signals characterizing the display device and in particular the imaging forming device as the operational parameters of the display device change over time.

It is an advantage of this embodiment that the desired image quality can be maintained throughout changes in the operational parameters of the display device.

In an embodiment of the display system according to the present invention, the optical sensor unit and the light source are shielded from the ambient light by an enclosure.

It is an advantage of this embodiment that the quality of the calibration (and thus the achievable image quality) is not affected by the ambient light conditions.

In an embodiment of the display system according to the present invention, the optical sensor unit comprises a photodiode, a photogate, a photoresistor, or phototransistor.

In an embodiment of the display system according to the present invention, the optical sensor unit comprises an array of photodiodes.

These components may advantageously be used to convert varying amounts of incoming light into varying electrical signals.

In an embodiment of the display system according to the present invention, at least one of the photo-sensors is covered with a color filter.

In that embodiment, the spectrum of the light impinging on the at least one photo-sensor can be made different from the spectrum of the light impinging on other photo-sensors, and calibration can be performed accurately for different color channels.

In an embodiment of the display system according to the present invention, the active display area is located on a first side of the display device and the representative part is located on a second side of the display device.

The part representative of the image forming device can be positioned on the other side of the display area, towards the back or second side of the display device. In other words, the part representative of the image forming device can be positioned behind the display area from the perspective of a viewer looking at the image displayed on the display area. More generally, the part representative of the image forming device can be located outside of the plane of the display area.

In an embodiment of the display system according to the present invention, the representative part is a portion of the image forming device which is arranged at an angle relative to the surface of the active display area.

In cases where the electro-optic layer is a sheet-like material, the representative part of the display device can be formed by bending the sheet at an angle with the first side (active display area) of the image forming device.

It is an advantage of these embodiments that the representative part, which is used for calibration purposes and is “lost” for imaging purposes, does not consume any useful area in the display plane or disturb the actual image.

In an embodiment of the display system according to the present invention, the image forming device and a first array of pixel electrodes configured to drive the image forming device are arranged on a substantially planar first substrate, interconnections to apply voltage signals to said pixel electrodes are arranged on an interconnection side of the first substrate; the system further comprises a flexible second substrate with a second array of pixel electrodes on a first side of the second substrate, the second substrate extending over at least one of the interconnections, the second side of the second substrate being in contact with the interconnection side of the first substrate, and the image forming device extends over the second array of pixel electrodes.

It is an advantage of this embodiment that nearly seamless tiling of multiple display devices becomes possible, because the space at the periphery of the display devices which is normally taken up by drivers or driver connections can at least partly be used as part of the imaging area.

The display device may further comprise one or more driver circuits to control the voltage signals applied to the first array of pixel electrodes. To reduce the non-display area imposed by the presence of the interconnections, a peripheral flexible substrate with a circuit with a second array of pixel electrodes extending over at least one of the interconnections is positioned on the first side of the display substrate. The peripheral flexible circuit has a first side and a second side, the first side facing the image forming device and the second side facing the first side of the display substrate. Voltage signals are applied to the second array of pixel electrodes to drive at least part of the image forming device directly above the second array of electrodes.

As the peripheral, second circuit is flexible, it is possible to arrange any required connections outside of the plane in which the image is formed, thus avoiding a negative contribution to the display area of the display device.

Additional interconnections can be added on the first side of the display substrate. Those additional interconnections are connected to the pixel electrodes on the first side of the flexible substrate by means of e.g. conductive vias in the flexible substrate.

Conductive tracks can be formed on the second side of the flexible substrate and connected to the interconnections on the first side of the display substrate via an anisotropic conductive film adhesive.

A part of the flexible substrate with the conductive tracks extends over an edge of the display substrate and provides the connections to the driver circuits. These driver circuits may be located on the flexible substrate itself or on a separate printed circuit board to which the flexible substrate is connected.

In a particular embodiment, signals are applied to the second array of pixel electrodes to drive at least part of the image forming device directly above the second array of pixel electrodes.

In a particular embodiment, at least one pixel electrode of the second array of pixel electrodes is connected to an interconnection formed on the first substrate.

In a particular embodiment, a TFT active matrix is formed on the interconnection side of the first substrate to address the first array of pixel electrodes via a set of row and column interconnections.

In a more particular embodiment, part of the TFT active matrix also addresses the second array of pixel electrodes and the second substrate connects the second array of pixel electrodes with said part of the TFT active matrix.

In a particular embodiment, a part of the second substrate is bent away from a plane in which the image is to be displayed, and wherein the image forming device and the second array of pixel electrodes substantially cover or hide the first substrate and the bent part of the second substrate.

These embodiments represent advantageous ways to implement the variant of the invention in which a second, flexible substrate is used.

According to an aspect of the present invention, there is provided a method for producing a display system, the display system comprising: a display device having an image forming device and an electronic driving system for driving the image forming device; a light source to illuminate a representative part of the display device; and an optical sensor unit comprising an optical aperture and at least one photo-sensor, configured to generate optical measurement signals from optical measurements; the method comprising: arranging the light source and the optical sensor unit on one side of the display device, such that the optical sensor unit is arranged to make optical measurements from light reflected by a representative part of the display device; and integrating the light source and the optical sensor unit with the display device.

The light source and the optical sensor unit may be permanently integrated with the display device. The display system produced by the method according to the present invention may more specifically be a display system according to any of the embodiments described herein.

According to an aspect of the present invention, there is provided a method for calibrating the display device of the display system described above, the method comprising using the optical measurement signals to determine a compensation factor to be applied to subsequent image signals supplied to the driving electronics.

The present application also discloses a system for reduction of the non-display area of a display device, which may be applied independently from the above mentioned aspects of the present invention. Thus there is disclosed a display device, comprising: a substantially planar first substrate, an image forming device and a first array of pixel electrodes to drive the image forming device, and interconnections to apply voltage signals to the pixel electrodes arranged on an interconnection side of the first substrate; wherein a flexible second substrate with a second array of pixel electrodes on a first side of said second substrate extends over at least one of the interconnections, the second side of the second substrate being in contact with the interconnection side of the first substrate, and wherein the image forming device extends over the second array of pixel electrodes.

In an embodiment of the display device, signals are applied to the second array of pixel electrodes to drive at least part of the image forming device directly above the second array of pixel electrodes.

In an embodiment of the display device, at least one pixel electrode of the second array of pixel electrodes is connected to an interconnection formed on the first substrate.

In an embodiment of the display device, a TFT active matrix is formed on the first side of the first substrate to address the first array of pixel electrodes via a set of row and column interconnections. In a particular embodiment, the TFT active matrix also addresses the second array of pixel electrodes and the second substrate connects the second array of pixel electrodes with said part of the TFT active matrix.

The technical effects and advantages of the embodiments of the display device described above, correspond mutatis mutandis to those of the corresponding embodiments of the display system according to the present invention.

### BRIEF DESCRIPTION OF THE FIGURES

These and other features and advantages of embodiments of the present invention will now be described in more detail with reference to the accompanying drawings, in which:

FIG. 1 schematically illustrates an active display tile according to an embodiment of the present invention;

FIG. 2 provides a flow chart representing an exemplary calibration cycle;

FIG. 3 illustrates driver circuits and interconnections at the periphery of an LCD display tile;

FIG. 4 illustrates a cross section of the side of a display tile;

FIG. 5 illustrates a simple active matrix structure; and

FIG. 6 provides a block diagram of the electronics involved in the calibration cycle of FIG. 2.

### DETAILED DESCRIPTION OF EMBODIMENTS

The invention will hereinafter be described with reference to a display system comprising a display device or “display tile”. The display device comprises an image forming device 5. In embodiments of the invention, this image forming device 5 may substantively consist of an electro-optic layer, in particular an electrophoretic sheet or panel, more in particular an electrophoretic sheet or panel of the reflective type.

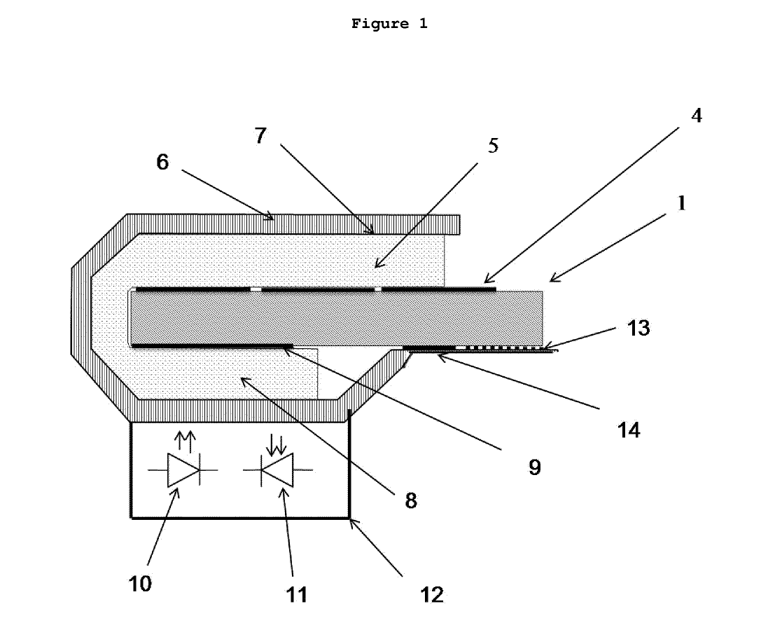

As seen on FIG. 1, a display device, or “display tile”, comprises a substrate 1 having a first side and a second side. An array 2 of pixel electrodes 4 is formed on the first side of substrate 1. The substrate is made out of e.g. glass. Depending on the addressing scheme for the array of pixel electrodes, an epoxy resin or any other suitable material could also be used. The array of pixel electrodes is driven by driver circuits or “drivers” 3. The drivers 3 can be positioned remotely from substrate 1 or on the second side of the substrate 1. In the case where the drivers 3 are positioned remotely, the connection of the drivers 3 to the array 2 on the first side of substrate 1 may be done with a flexible substrate as will be described later. An image forming device 5 such as a flexible reflective electrophoretic sheet or panel is placed on the array 2. The image forming device 5 comes with a protective foil 6 and transparent front electrode 7. The active display area is determined by the area of the image forming device 5 that can be driven by the pixel electrodes 4 of the array 2.

In the illustrated embodiment, a portion 8 of the image forming device 5 is wrapped around an edge of the substrate 1. At least one calibration electrode 9 has been formed on the rear side of the substrate 1, e.g. in the vicinity of the edge of the substrate 1 around which the portion 8 of the image forming device 5 is wrapped. The portion 8 of the image forming device 5 extends over at least part of the at least one pixel electrode 9. A light source 10 or a means for providing light is positioned in the vicinity of the portion 8 of the image forming device 5. Light cast by light source 10 on the portion 8 of the image forming device 5 at the position of the calibration electrode 9 is reflected towards a light sensor 11. The light sensor 11 can be e.g. a photodiode, a photogate, photoresistor or phototransistor; an array of photodiodes, photogates, photoresistors or phototransistors, or in particular a spectrometer. The light sensor 11 can be configured to measure the intensity of the reflected light only; or to give information about the colors of the light reflected as well. Where necessary, colored filters can be used with the sensor 11 to allow intensity measurements depending upon color. An enclosure 12 shields the portion 8 of the image forming device 5, the light source 10, and the light sensor 11 from stray light, e.g. ambient light.

The image forming device 5 is fastened to the second side of the substrate 1 and protected from environmental effects such as moisture ingress by a sealing component 13, e.g. glue. The glue is usually applied to a portion of the protective sheet 6 extending beyond the edge of the portion 8 as seen on FIG. 1B. The common electrode 7 is connected to the driver circuit via the electrode 14 formed on the second side of the substrate 1.

If the substrate 1 is not opaque, a mask is formed between the rear side of the substrate and the at least one calibration electrode 9 to prevent light impinging on the first side of substrate 1 from entering the enclosure 12.

Under the premise that the portion 8 is representative of the active display area of the image forming device 5, the portion 8 can be used to derive measurements relative to the active display area and correct accordingly the gray level and/or color of an image displayed on the display area of the image forming device 5.

To that end, the at least one calibration electrode 9 is driven at different voltage levels and/or pulse durations to realize different levels of gray on the at least one calibration electrode 9 of the portion 8 of the image forming device 5. During calibration of the image forming device 5, the light source 10 emits a constant level of light in the enclosure 12.

The light emitted by the light source 10 is reflected by the portion 8 of the image forming device 5, at the position of the calibration electrode 9, towards the sensor 10.

A first gray scale response of the portion 8 of the image forming device 5 is stored as e.g. a first look-up table by a controller controlling the display tile. The first look-up table is used to drive the pixel electrodes 4 and display images on the active display area with the expected gray levels and/or colors.

A baffle 10a can surround the sensor 10. The baffle limits e.g. the viewing angle of the sensor to that part of portion 8 that can be set to different grey levels by driving the at least one calibration electrode 9, and prevents the light emitted from the light source 11 from being directly incident on the sensor 10.

Diverse improvements can be made to decrease the influence of light reflected by the walls of enclosure 12 towards the sensor. A first optional improvement consists of covering the inner walls of enclosure 12 with a light absorbing layer like e.g. black matte paint. A second optional improvement consists in measuring the level of ambient or stray light having entered the enclosure 12 and subtracting it from measurements, as will be detailed later. After filtering, the signal related to the light reflected by the area corresponding to the at least one calibration electrode 9 will remain and any influence of the ambient or stray light will have been canceled or at least reduced.

To be as representative of the active display area as possible, portion 8 should be subjected to the same physical stresses. This is not necessarily the case; in particular for temperature. Indeed, while most of the image forming device 5 will be exposed to direct sunlight; portion 8 will remain shielded from it by the substrate 1 and the enclosure 12. The substrate 1 being typically made of glass or epoxy resin, and the image forming device 5 being a poor thermal conductor, one may consider that the portion 8 is thermally isolated from the rest of the panel. Thermal conduction between the front of the panel and portion 8 through the atmosphere is also reduced because of the shield 12.

Thermal conduction between the first side and the second side of the substrate 1 can be increased with the help of vias in the proximity of the calibration electrode 9 in the substrate 1, if the material of the substrate allows for it. This will help minimizing the temperature gradient between the first and second side of the substrate in the vicinity of the calibration electrode 9.

A heater resistor can be placed in the vicinity of portion 8. The heater resistor can be placed in the direct vicinity of portion 8, e.g. a thin film resistor may be positioned under the portion 8. Alternatively, the heat dissipated by the heater resistor can be distributed by forced convection throughout the enclosure 12 by a fan or by conduction. The heater resistor can be replaced by a Peltier element to accommodate both negative and positive temperature gradients between the first and second side of substrate 1.

In an embodiment, a first temperature sensor monitors the temperature of portion 8 or in the vicinity of portion 8. A second temperature sensor is placed on the first side of the substrate 1, e.g. under the image forming device 5. In particular, the temperature sensor can be synthesized with one or more thin film transistors on the substrate 1. A control loop regulates the temperature in the vicinity of portion 8 to match the temperature in the vicinity of the active display area of the image forming device 5 as measured by the second temperature sensor.

The gray scale response of the image forming device 5 after the application of a voltage V for a time period t is depending upon a number of factors, in particular one or more of:
the start situation of the pixel;
the duration t, amplitude V, and polarity of the voltage pulse;
the thickness and dielectric constants of the image forming device 5;
the charge of the electrophoretic particles, where present;
the mobility of the electrophoretic particles, where present, in the fluid.

The latter three parameters can be influenced by production process, material properties, temperature and age, etc.

For every display area, a calibration process needs to be executed. To mitigate the effect of temperature and potential effects of aging, this invention proposes a regular and automated calibration process.

In what follows, it is assumed that the image forming device 5 is driven in pulse width modulation (PWM) mode with a voltage of a fixed amplitude V with appropriate polarity. However, a similar approach would be applicable when the image forming device 5 is driven with a voltage pulse of constant duration and variable voltage level.

Thus, for the purpose of the following description, the drivers are assumed to provide a pulse of a given duration with voltage +V or −V or 0. The driving condition is therefore fully defined by the pulse duration and the polarity.

During the calibration process, the gray scale response of the image forming device 5 is characterized and stored into a look-up table. When both the input image data of the previous image (X) (start situation of the pixel) and the input image data of the current image (Y) (desired end situation of the pixel), are provided at the input of the look-up table, the pulse duration and polarity can be read at the output.

If a reset to a known rail state (black or white) is applied before driving the image forming device 5 to the desired gray level, then it is sufficient to have only the current input image data at the input of the look-up table.

For every measurement made, the optical sensor is first read without the light source activated. This is done to eliminate the effects of any residual ambient light reaching the sensor. Then the measurement is repeated with the light source activated. The differential between the two values indicates the response to the light from the light source. While the measurement is executed sequentially, the time interval between the two measurements would be small enough such that no significant change in the ambient light level will occur. Multiple measurements can be taken and median filtering applied to avoid occasional fast fluctuations of ambient light (for example shadow from a bird flying over).

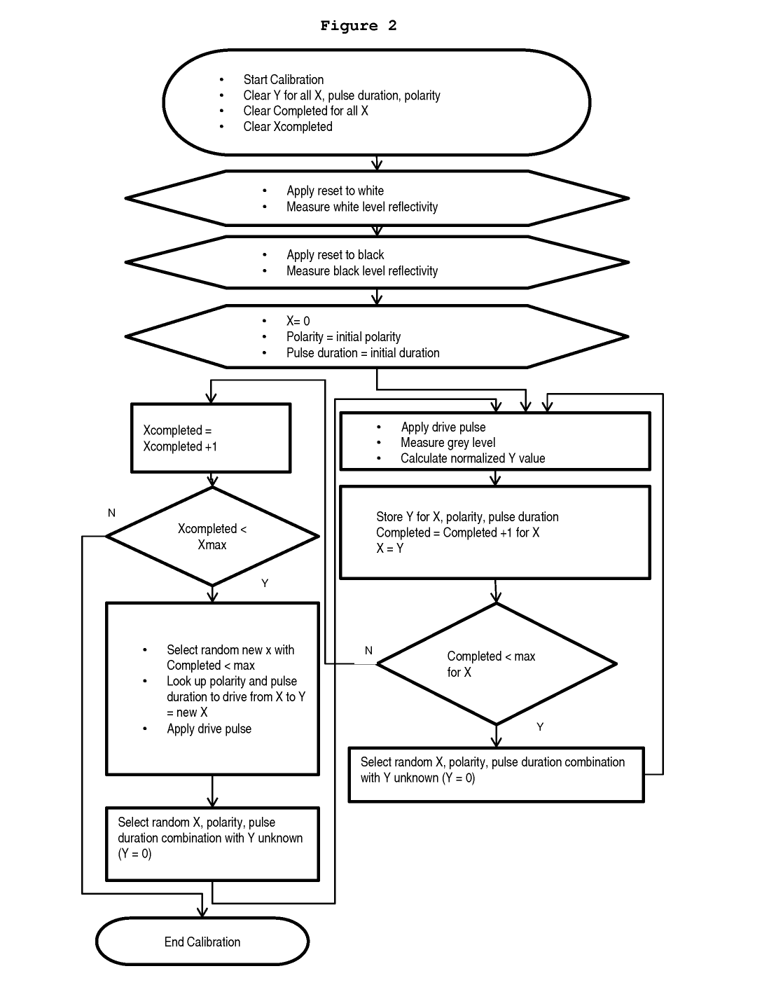

An example of a calibration cycle is illustrated in FIG. 2. In FIG. 2, X represents the input value, i.e. the amplitude of the voltage pulse applied to the at least one pixel electrode 9 and Y represents the output value, i.e. the gray level (or more generally the amount of light reflected by the portion 8 of the image forming device 5 as a fraction of the light emitted by light source 10), driven by the at least one calibration electrode 9. First, the reflectivity of the extreme states (i.e., black and white) is measured. These values serve to normalize the response of the further measurements (black state=minimum Y value, white state=maximum Y value).

The Y-value obtained from a certain X value after the application of a pulse with a given duration and polarity will depend on the operational parameters of the image forming device 5. This is precisely the reason for the calibration to be performed, but as the response of the image forming device 5 is unknown, it is also impossible to perform the calibration in a planned and orderly fashion. Therefore it is proposed to execute the calibration process to characterize all transitions from grey level X to gray level Y as a semi-random walk as described below.

After a reset to black, an initial pulse is applied to the image forming device 5. The duration and polarity of this initial pulse are selected such that a transition from black to grey will be obtained. The pulse is applied to the at least one calibration electrode 9 and the grey level is measured by photosensor 11 at a given and constant level of light emitted by light source 10. The normalized grey level Y is calculated.

For example, if Y is an 8-bit value; then the minimum Y value of 0 is related to black and the maximum Y value of 255 is related to white. If a gray level is measured that is equal to the black level+⅓ of the difference between black and white, then the normalized Y value would be ⅓ of 255=85.

Now we know that when we start from grey level X=0 and we apply a pulse duration D with a polarity P, we obtain a grey level Y. In the table with input values X=0, D, P we store value Y. The process is now one step closer to completion for all valid pulse duration/polarity combinations for start value X, and the counter Completed is incremented.

Whatever the obtained Y-value is, because this depends upon the operating conditions of the image forming device 5, it becomes the new X-value for the following calibration step. Y could be different the next time the calibration is performed, for example because the ambient temperature is different. As long as not all end values Y for a certain start value X are filled in, again a semi-random pulse duration/polarity combination is chosen, with the only condition being that it is different from pulse duration/polarity combinations with already known results Y.

So we are jumping back and forth between gray levels in a random order. The final goal is that for every start value X and desired end value Y we know exactly what pulse duration and polarity we need for the driving voltage.

When, for a certain starting position X, all valid pulse duration/polarity combinations have known results Y, that X value is marked as completed. And the counter X-completed is incremented. Then a pulse duration-polarity combination is selected to drive to an X-value not yet marked as completed. After that this pulse is applied, again a semi-random duration/polarity combination is chosen, with the only condition being that it is different from pulse duration/polarity combinations with already known results Y. And the calibration process is continued. When all X-values are marked completed the calibration cycle is finished.

The look-up table can now be inverted to show the pulse duration polarity output as a function of (X,Y) input and loaded into the electronic driving system for processing the input image. When for a certain start value X, multiple pulse durations are valid to achieve and end value Y, the average pulse duration is calculated and rounded.

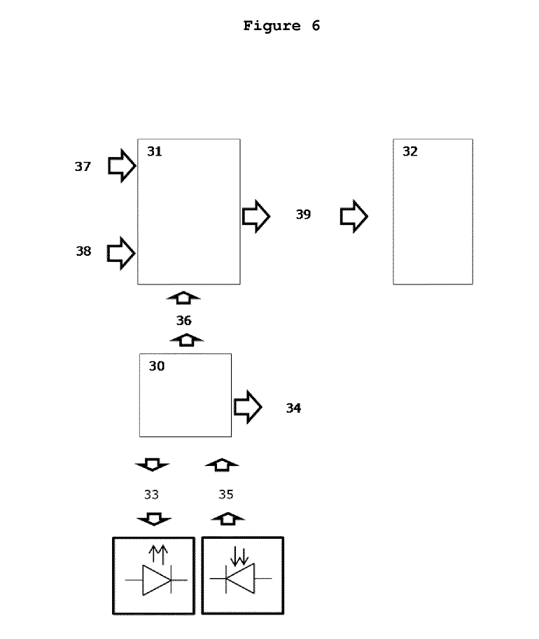

In FIG. 6, a block diagram of the electronics is illustrated. A controller 30 performs the calibration process. The controller 30 provides a drive signal for the calibration electrode 9, reads the measurement signal 35 coming from sensor unit 11. The controller also sends a signal 33 to control the activation of light source 10. The controller can be provided by a microcontroller, or any other suitable electronic device such as an FPGA or microprocessor and memory.

A display controller 32 provides drive signals to the matrix 2 of pixel electrodes 4. At the input there is the image input data 37, as well as the previous image data 38. The previous image data being obtained from an image frame buffer memory. Both inputs are provided to look-up table 31. At the output of this look-up table 31, there is information about pulse duration and polarity of the drive signal that needs to be generated.

Each time that controller 30 completes a calibration cycle, new content 36 can be loaded in look-up table 31.

Preferably, the loading of new look-up table data remains invisible. Therefore, new data is preferably loaded in periods where no new image data is written to the display. Alternatively, two look-up tables are implemented, to enable reading of a first look-up table while writing the second look-up table or vice versa.

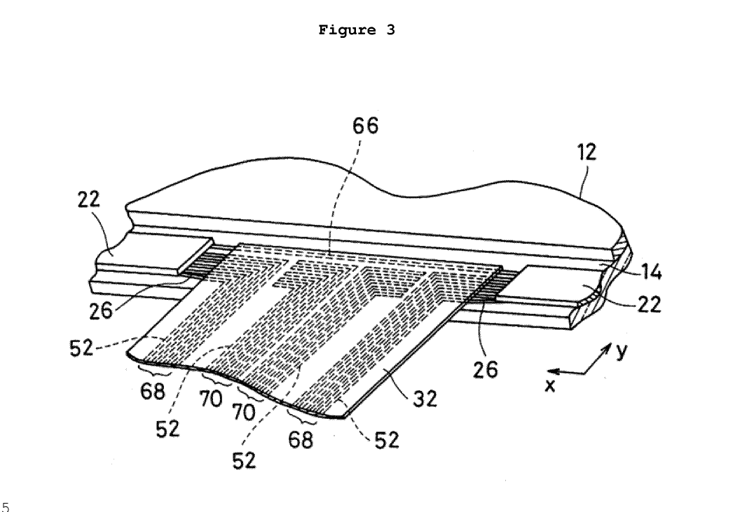

As exemplified on FIG. 3, the driver circuits and interconnections at the periphery of an LCD display tile do not contribute to the display area and as such they contribute to the seam between the display areas on adjacent display tiles. A similar problem arises with electrophoretic displays. Signals must be routed along conducting tracks to the array 2 of pixel electrodes driving the image forming device. The conducting tracks are usually bundled together at the periphery of the tile before a flexible substrate connects them to the driver circuits. There can therefore be no pixel electrodes at those peripheral regions occupied by the interconnection conducting tracks. Embodiments of the present invention solve the problem by means of a peripheral flexible substrate 21 positioned above the interconnections 17.

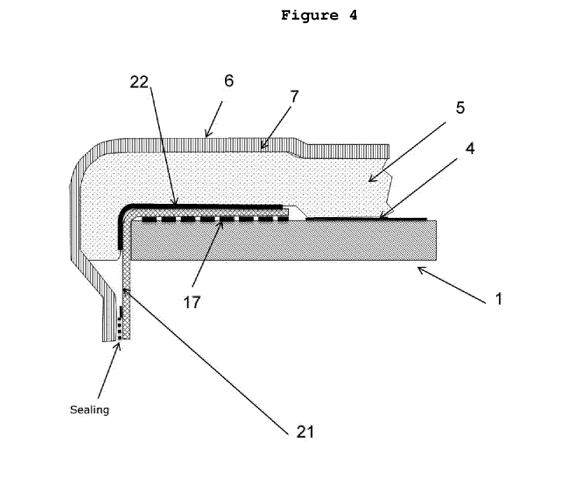

As seen on FIG. 4, the size of the non-display area is reduced by use of a separate substrate 21 placed atop the substrate 1. Pixel electrodes 22 are formed on substrate 21. Connections 23 are made between the pixel electrodes 22 and the interconnections 17 thereby allowing signals carried by the interconnections 17 to drive the pixel electrodes 22 and form a corresponding image on the image forming device 5 above the interconnections 17. The connections 23 can be made through vias (not shown) extending from one side of the separate substrate 21 to another side of substrate 21. The separate substrate 21 is advantageously flexible, such that part of its surface can be bent away from the plane in which the image is to be displayed.

The peripheral flexible circuit 21 has a first side and a second side, the first side facing the image forming device and the second side facing the first side of the display substrate.

Conductive tracks can be formed on the second side of the flexible substrate and connected to the interconnections on the first side of the display substrate.

In the case where a TFT (Thin Film Transistor) active matrix is formed on the display substrate 1, the thin film transistors for switching the pixel electrodes 22 on the flexible circuit 21 are still integrated on the display substrate 1.

A part of the flexible substrate with the conductive tracks extends over an edge of the display substrate and provides the connections to the driver circuits.

There are two options to place the driver circuits. They can be placed on the flexible circuit 21 itself or they can be placed on a remote printed circuit board to which the flexible circuit 21 is connected by means of a flex foil connector or conducting tracks formed on the flexible substrate 21.

The pixel electrodes 22 are positioned above the interconnections 17 and drive the image forming device 5 in the periphery of the display tile, thereby decreasing the size of the non-display region.

The separate substrate 21 can be a flexible substrate in a suitable material like e.g. polyimide.

A flexible substrate 21 can have pixel electrodes 22 on a first side and electrically conducting tracks 25 on a second side. The conducting tracks 25 are connected to the interconnections 17 on a first side of substrate 1.

The separate substrate 21 can accommodate one or more rows of pixel electrodes 22 in function of the dimensions of the bundle of interconnection electrodes 17 at the periphery of the substrate 1.

Further aspects of the embodiment illustrated in FIG. 4 will now be described. A glass substrate 1 containing an active matrix TFT backplane is laminated with an electro-optic foil such as provided by the company E-ink. The top of this foil is a transparent flexible substrate 7 covered with a transparent common electrode 6. Onto this foil a layer of micro-encapsulated electrophoretic material is coated. Thus, the electro-optic foil with the electrophoretic material forms an image forming device 5. A self-adhesive layer is provided in the back of the electro-optic layer.

In the center of the display tile the electro-optic layer is laminated onto the glass substrate 1 with TFT backplane containing the pixel electrodes 4. The electro-optic layer is addressed by the electrical field in between the pixel electrodes 4 and the common electrode 6.

At the side of the display, a flexible interconnect circuit 21 is arranged, preferably laminated, onto the glass substrate 1.

This flexible interconnect circuit 21 serves the purpose of contacting the row or column lines of the active matrix and extending those connections to remote row and column driver circuits 3 respectively. In order to establish those connections, use is made of an anisotropic conductive adhesive film such as 3M ECATT 9703.

The image forming device 5 is extended over this flexible interconnect circuit 21 such that this area now can also be driven with active image information. Here, the image forming device 5 will be slightly elevated. Now the pixel electrode 22 is provided on the top of the flexible interconnect circuit 21. The electrical field between the pixel electrode 22 on top of the flexible interconnect circuit and the common electrode 6 on the transparent protective foil 7 will be similar to the electrical field in the center of the display tile for the same driving voltage.

The connection between the pixel electrode 22 on the flexible interconnect circuit 21 and the thin film transistor on the glass substrate is also made via a trace on the glass substrate 1 contacting a trace at the bottom of the flexible interconnect circuit 21 through the same anisotropic conductive adhesive. A via through the flexible interconnect circuit 21 is then extending this connection to the top pixel electrode 22

While both the interconnect circuit 21 and the electro-optic layer in the form of an electrophoretic layer or panel 5 are flexible, a minimal bending radius needs to be respected. For example a radius of between 0.5 mm and 1 mm. This bending radius could again increase the gap between the active display areas between adjacent tiles.

Advantageously, image forming device 5 and the pixel electrode 22 are made to extend over substrate 1 and over the bent area of the flexible interconnect circuit, such that the unaddressed area between 2 adjacent tiles is further minimized.

The bent area will become more or less visible to the viewer depending on the viewing angle. Therefore, the intersection between display tiles is preferably chosen such that both bent areas of two adjacent display tiles are part of the same (sub)pixel. In this case, as the bent area of one display tile becomes less visible, the bent area of the adjacent display tile becomes more visible. To the viewer a (sub)pixel with constant surface (and therefore brightness) continues to be observed regardless of his viewing position.

All (sub)pixels are designed such that the active display area they contain is constant regardless of whether they are located at the center of the tile or at the intersection between tiles. As far as possible, the pixel pitch (the distance between the centers of two adjacent pixels) is maintained constant.

Where the image forming device 5 transitions from contacting the glass substrate 1 to contacting the flexible interconnect circuit 21, the resulting electrical field across the electro-optical layer in the form of an electrophoretic layer or panel might deviate and be susceptible to alignment and process tolerances. It is therefore preferred to make this transition coincide with the inactive area in between adjacent (sub)pixel electrodes.

The proposed solution is advantageous for display tiles with a rather large pixel pitch. For example, we consider a pixel pitch of 6 mm, each pixel containing subpixels of red, green, blue and white color. A subpixel then has size of 3×3 mm. A double sided flexible interconnect circuit 21 is used with a thickness of around 100 μm. The image forming device 5, laminated on top of the substrate 1 also has a thickness of approximately 100 μm. It is recommended that the bending radius of the flexible interconnect circuit is at least 6 times the height of the flexible interconnect circuit. The bending radius therefore preferably is at least 0.5 mm.

In order to minimize the effect of the bending radius, when viewing at an angle, the tile boundaries are set to divide a subpixel area in two halves. A flexible circuit is attached at the four sides of the display tile. The projection of the visible area of each subpixel then remains identical at the tile boundaries compared to the central area of the tile, and this at every viewing angle. Each half subpixel is then 1.5 mm wide. The overlap zone between the glass substrate and the flexible interconnect circuit is chosen to encompass one complete and one half subpixel minus the bending radius, and thus extends over 4 mm. This should be sufficient to reliably fix and interconnect the flex circuit with the glass substrate, its active matrix, and both subpixels.

The image forming device 5 is then sealed to the flexible interconnect circuit 21. The common electrode 6 is connected to the driver circuit via the electrode 14 formed on the flexible interconnect circuit 21.

The image forming device 5 can still be further extended over the flexible interconnect circuit 21 to include on this flexible interconnect circuit a calibration electrode 9 as discussed above. Such that a calibration system (with light source 10 and light sensor 11) can then be positioned in the rear side of the display tile.

Alternatively, it is possible to opt for half-tone driving of gray scales rather than analog gray scale driving. Here the subpixel area is further divided into as many areas as there are bits in the grey scale. The area of each respective subdivision corresponds to the binary weight of the bits. For example, to enable a 5-bit grey scale, there will be five areas per subpixels:

| | |
|---|---|
| MSB | ½ subpixel area |
| MSB-1 | ¼ subpixel area |
| MSB-2 | ⅛ subpixel area |
| MSB-3 | 1/16 subpixel area |
| LSB | 1/32 subpixel area |

Per subpixel there are now at least five TFT switches for switching the different areas and a row select line for each of those TFT switches.

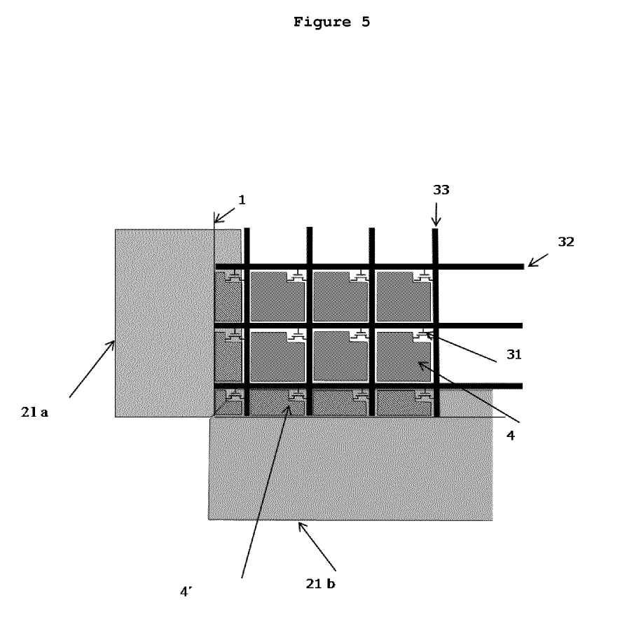

A simple active matrix structure is illustrated in FIG. 5. Full pixel electrodes 4 and partial pixel electrodes 4′ are formed on substrate 1, which is typically a glass substrate. Every pixel electrode 4 is connected via a thin film transistor (TFT) 31 to a column interconnect line 32. The gate of the TFT 31 is connected to the row select interconnect line 33. A flexible printed circuit board 21 is used to connect row and column interconnect lines to a remote driver circuit 3. The position of the pixel electrodes in the periphery of the display tile 4′ overlaps with the flexible interconnect circuit 21. In FIG. 9, the overlap zone is slightly less than half of a pixel and stops in between the pixel electrode 4′ and the pixel electrode 4. However the overlap zone can also include additional pixel electrodes 4. To enable addressing of the pixel(s) in the overlap zone, a second array of pixel electrodes 22 is applied at the top of the flexible interconnect circuit 21. These top pixel electrodes are not shown in FIG. 5, but largely coincide with the position of the pixel electrodes 4′ with the difference that they extend over the edges of the substrate 1, to enable driving of the image forming device 5 over the radius of curvature, as discussed previously. A connection from the pixel electrode to the corresponding TFT switch is also made via the flexible interconnects circuit 21. Therefore the flexible interconnect circuit has two additional functions next to the traditional extension of row and column interconnects lines to remote driver circuits 3:
1. provide pixel electrodes on top to drive the peripheral pixels (at least partly)
2. connect the driver TFT for those peripheral pixels to these electrodes.

At the corner of the substrate 1, the flexible row interconnects circuit 21a and the flexible column interconnect circuit 21b make a 45 degree angle. This 45 degree angle extends slightly beyond substrate 1 to accommodate the bending radius. When four corners of adjacent display tiles are put next to each other, together the corners will make up a full pixel area.

While the invention is susceptible to various modifications and alternative forms, specific examples are shown in the drawings and described in detail. It should be understood, however, that the invention is not limited to the particular forms or methods disclosed. Rather, the invention is intended to cover all modifications, equivalents and alternatives falling within the scope of the claims.

1-25. (canceled)

26. A display system, comprising:
a display device having
an image forming device and
an electronic driving system for driving the image forming device;
a light source to illuminate a representative part of the display device; and
an optical sensor unit comprising an optical aperture and at least one photo-sensor, arranged to make optical measurements from the light reflected by said representative part and configured to generate optical measurement signals therefrom;
wherein the light source and the optical sensor unit are on one side of the display device;
wherein the light source and the optical sensor unit are integrated with the display device;
wherein the representative part is a continuation of the image forming device; and
wherein the representative part is wrapped around an edge of the substrate.

27. The display system according to claim 26, wherein the light source and the optical sensor unit are configured to update the optical measurement signals as the operational parameters of the display device change over time.

28. The display system according to claim 26, wherein the optical sensor unit and the light source are shielded from the ambient light by an enclosure.

29. The display system according to claim 26, wherein the optical sensor unit comprises a photodiode, a photogate, a photoresistor, or a phototransistor.

30. The display system according to claim 26, wherein the optical sensor unit comprises an array of photodiodes.

31. The display system according to claim 26, wherein at least one of said photo-sensors is covered with a color filter.

32. The display system according to claim 26, wherein the representative part is a portion of the image forming device which is arranged at an angle relative to the surface of the active display area.

33. The display system according to claim 26, wherein said image forming device and a first array of pixel electrodes configured to drive said image forming device are arranged on a substantially planar first substrate,
wherein interconnections to apply voltage signals to said pixel electrodes are arranged on an interconnection side of the first substrate;
the system further comprising a flexible second substrate with a second array of pixel electrodes on a first side of said second substrate, said second substrate extending over at least one of said interconnections, the second side of the second substrate being in contact with the interconnection side of the first substrate, and
wherein the image forming device extends over the second array of pixel electrodes.

34. The display system according to claim 33, wherein signals are applied to the second array of pixel electrodes to drive at least part of the image forming device directly above the second array of pixel electrodes.

35. The display system according to claim 33, wherein at least one pixel electrode of the second array of pixel electrodes is connected to an interconnection formed on the first substrate.

36. The display system according claim 33, wherein a TFT active matrix is formed on the interconnection side of the first substrate to address the first array of pixel electrodes via a set of row and column interconnections.

37. The display system according to claim 36, wherein part of the TFT active matrix also addresses the second array of pixel electrodes and the second substrate connects the second array of pixel electrodes with said part of the TFT active matrix.

38. The display system according to claim 33, wherein a part of the second substrate is bent away from a plane in which the image is to be displayed, and wherein the image forming device and the second array of pixel electrodes substantially cover or hide the first substrate and the bent part of the second substrate.

39. A method for producing a display system, the display system comprising:
a display device having:
an image forming device and
an electronic driving system for driving the image forming device,
a light source to illuminate a representative part of the display device, and
an optical sensor unit comprising an optical aperture and at least one photo-sensor, configured to generate optical measurement signals from optical measurements;
the method comprising:
arranging the light source and the optical sensor unit on one side of the display device, such that the optical sensor unit is arranged to make optical measurements from light reflected by a representative part of the display device, and
integrating the light source and the optical sensor unit with the display device;
wherein the representative part is a continuation of the image forming device; and
wherein the representative part is wrapped around an edge of the substrate.

40. A method for calibrating the display device of the display system according to claim 26, the method comprising using the optical measurement signals to determine a compensation factor to be applied to subsequent image signals supplied to the electronic driving system.
